(19) United States
(12) Patent Application Publication
(10) Pub. No.: US 2013/0298742 A1
(43) Pub. Date: Nov. 14, 2013

(54) WORK PIECE GUIDE DEVICE

(71) Applicant: Rudolf Fuchs, Neuhausen (DE)

(72) Inventor: Rudolf Fuchs, Neuhausen (DE)

(73) Assignee: Robert Bosch GmbH, Stuttgart (DE)

(21) Appl. No.: 13/876,814

(22) PCT Filed: Aug. 8, 2011
(86) PCT No.: PCT/EP2011/063588

§ 371 Date: Jun. 10, 2013

(30) Foreign Application Priority Data
Oct. 4, 2010 (DE) 10 2010 041 927.3

(51) Int. Cl. B27B 25/10

(52) U.S. Cl. CPC B27B 25/10
USPC 83/444

(57) ABSTRACT

A work piece guidance system, in particular for a circular table saw, has a parallel stop unit and a work piece guide device each having at least one coupling region. The coupling regions are configured to be coupled to each other to guide the work piece guide device along the parallel stop unit.

### PRIOR ART

Work piece guide devices are already known from the field of machine tools, in particular circular table saws. In order to avoid contact between an operator and moving parts of the tool machine, freely movable push sticks are used in particular, which are held at one end by the operator and at another end are in contact with a work piece during a pushing process.

### DISCLOSURE OF THE INVENTION

A work piece guide system is proposed, in particular for a circular table saw, having a parallel stop unit and a work piece guide device, each having at least one coupling region and said coupling regions being provided to be coupled to each other to guide the work piece guide device along the parallel stop unit. In this context, a “parallel stop unit” is to be understood in particular to mean a unit that is provided for guidance of the work piece guide device over a work surface, in particular parallel to a direction of guidance. In this case, a “coupling region” is to be understood in particular to mean a region that is provided to couple and/or connect the parallel stop unit and the work piece guide device to each other so as to limit a freedom of movement of the work piece guide device, at least in part, and the region in particular has contact points, contact lines and/or contact areas, via which the parallel stop unit and the work piece guide device are contacted in at least one operating state. In this context a “work piece guide device” is understood in particular to mean a device that is provided to move a work piece along the parallel stop unit in a direction of guidance. The term “provided” is to be understood in particular to mean specially designed, equipped and/or connected. A work piece can be machined in a particularly simple and safe manner by means of the embodiment according to the invention of the work piece guide system.

It is also proposed for the coupling region of the work piece guide device to have at least one vertical guide element, which is provided to be guided over at least one vertical guide surface of the coupling region of the parallel stop unit. In this context a “vertical guide element” is to be understood in particular to mean an element that is provided, considered in an operating state, to absorb at least force components in the direction of a work piece support surface and/or in a direction turned away from the work piece support surface, and/or in particular to absorb at least force components in the direction of a force of gravity and/or in a direction turned away from the force of gravity. In this context a “vertical guide surface” is to be understood in particular to mean a surface of which the surface normal is arranged in particular at least substantially perpendicularly on the work piece support surface and/or in particular runs at least substantially parallel to a force of gravity at the location of the work piece guide system. In this context “substantially” is to be understood in particular to mean that deviations of less than 45° and in particular of less than 20° are present. Operation of the work piece guide device can thus be facilitated advantageously.

It is furthermore proposed for the coupling region of the work piece guide device to have at least one horizontal guide element, which is provided to delimit the movement of the work piece guide device in two opposed horizontal directions transverse to a direction of guidance. In this context a “horizontal guide element” is to be understood in particular to mean an element that is provided, considered in an operating state, to absorb at least one force component in a direction running parallel to the work piece support surface and/or in particular to absorb at least one force component in a direction running transverse to the force of gravity. In this context a “horizontal direction” is to be understood in particular to mean a direction that extends substantially parallel to the work piece support surface of the parallel stop unit and/or in particular transverse to the force of gravity. In this context a “direction of guidance” is to be understood in particular to mean a direction in which a work piece has to be guided during machining, in particular by a circular table saw. Due to an embodiment of this type, operation of the work piece guide device can be further facilitated.

If the work piece guide system has a protection device, which is provided to at least partially shield an operating region of the work piece guide device in the direction of a machining region, a particularly safe operating region can be created. In this context a “protection device” is to be understood in particular to mean a device that has a protection body, which can detain machining residues produced as a work piece is machined and can at least partially prevent an operator from entering the machining region. In this context an “operating region” is to be understood in particular to mean a region in which, in an operating state, an operator's hand is located to operate the work piece guide system. In this context a “machining region” is to be understood in particular to mean a region in which, in an operating state, a work piece is machined. In this context the term “shield” is to be understood in particular to mean to spatially separate and/or prevent a passage of solid and/or liquid matter. The protection body is preferably formed by a sheet metal, and more preferably by a plastics body, such as an acrylic glass body in particular.

In a further embodiment it is proposed for the work piece guide device to have an actuation unit that is provided to change an operating state of a machine tool, whereby particularly comfortable operation of the machine tool is enabled. An “actuation unit” is understood in particular to mean a unit that has a switch, by means of which a control process, in particular an electric control process, can be carried out, and/or by means of which a control signal, in particular an electric control signal, can be triggered.

In this case the actuation unit is preferably connected via an electric and/or electromagnetic connection unit to the machine tool. The connection unit can be provided for wired and/or wireless transfer of signals. The phrase “wireless transfer” is to be understood in particular to mean that a data transfer means of the connection unit is provided to emit a parameter via an advantageously bodiless information carrier, for example via sound waves, light waves and/or preferably radio waves. The data transfer means preferably transfers the signal through at least one insulator, such as air.

It is also proposed for the work piece guide device to have a pivotably mounted feed unit, which is provided to push a work piece along the parallel stop unit, whereby entry into the machining region to place the feed unit against the work piece is advantageously avoided and safety for an operator can thus be increased. A “feed unit” is to be understood in particular to mean a unit that has a driving stop that comprises a contact surface provided for direct contact with a work piece during a pushing process.

If the work piece guide system has an energy storing unit, which is provided to load a driving stop of the feed unit in a direction of support, a work piece can be pushed particularly reliably by the feed unit along the parallel stop unit.

The work piece can be fixed particularly reliably if the work piece guide system has a hold-down unit, which is provided to prevent movement of the work piece in a vertical direction. In this context a “vertical direction” is to be understood in particular to mean a direction that proceeds perpendicularly from the work piece support surface.

### DRAWING

Further advantages will emerge from the following description of the drawing. Exemplary embodiments of the invention are illustrated in the drawing. The drawing, the description and the claims contain numerous features in combination. A person skilled in the art will also consider the features individually and combine them to form meaningful further combinations as appropriate.

In the drawing:

FIG. 1 shows a perspective view of a circular table saw with a work piece guide system according to the invention,

FIG. 2 shows a perspective view of the work piece guide system from FIG. 1,

FIG. 3 shows a frontal view of a work piece guide system from FIG. 1,

FIG. 4 shows a frontal view of a second exemplary embodiment of a work piece guide system,

FIG. 5 shows a side view of the work piece guide system from FIG. 4,

FIG. 6 shows a plan view of the work piece guide system according to FIG. 4,

FIG. 7 shows a perspective view of a third exemplary embodiment.

### DESCRIPTION OF THE EXEMPLARY EMBODIMENTS

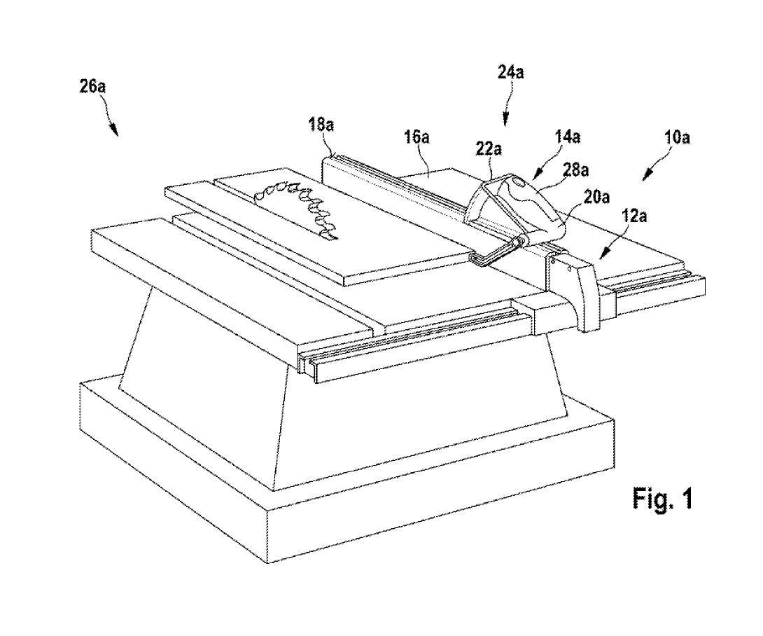

FIG. 1 shows a schematic perspective view of a circular table saw 10a with a work piece guide system according to the invention. The work piece guide system is arranged on a work surface 16a of the circular table saw 10a and has a parallel stop unit 12a and a work piece guide device 14a, which are formed by a profiled rail. The work piece guide device 14a rests on a support surface 18a of the parallel stop unit 12a.

A protection device 22a is screwed on to a main body 20a of the work piece guide device 14a and is produced from acrylic glass formed in one piece. The protection device 22a partially shields an operating region 24a of the work piece guide device 14a and a grip 28a in the direction of a machining region 26a. No solid, liquid or gaseous materials can penetrate the protection device 22a.

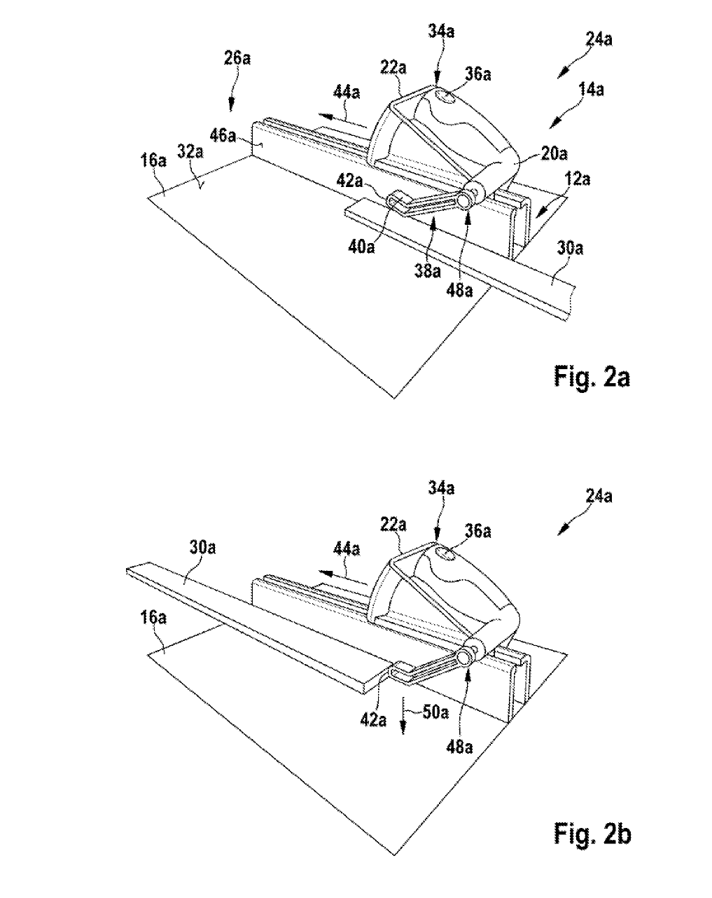

FIG. 2a shows a further perspective view of a work piece guide system and a work piece 30a, which rests on a work piece support surface 32a of the work surface 16a. In the operating region 24a, the work piece guide device 14a has an actuation unit 34a, which, upon actuation, changes an operating state of the circular table saw 10a. A dead man's switch 36a of the actuation unit 34a switches on the circular table saw 10a upon actuation. If the operator releases the dead man's switch 36a, the circular table saw 10a switches off automatically. All other switches known to a person skilled in the art, such as toggle switches, rocker switches, push-button switches, latching switches, sliding switches or rotary switches are also conceivable in this regard.

In the machining region 26a, the work piece guide device 14a has a feed unit 38a, which is formed by a one-piece, pivotably mounted lever arm 40a. A driving stop 42a, which pushes the work piece 30a on the work surface 16a along a guide surface 46a of the parallel stop unit 12a in a direction of guidance 44a upon contact with the work piece 30a and movement of the work piece guide device 14a, is arranged at one end of the lever arm 40a.

The work piece 30a is arranged below the driving stop 42a of the pivotably mounted lever arm 40a, said driving stop exerting force onto the work piece. A force acting on the work piece 30a as a result of the lever arm 40a is increased by an energy storing unit 48a formed as a wire spring. The energy storing unit 48a is arranged partially within the main body 20a.

FIG. 2b shows the work piece guide system in a position in which the work piece 30a is arranged after the driving stop 42a, as viewed in the direction of guidance 44a. The driving stop 42a rests on the work surface 16a, from where it is loaded by the energy storing unit 48a in a direction of support 50a directed perpendicular to the work surface 16a. As the work piece guide device 14a moves in the direction of guidance 44a, the work piece 30a is pushed by the driving stop 42a in the direction of guidance 44a.

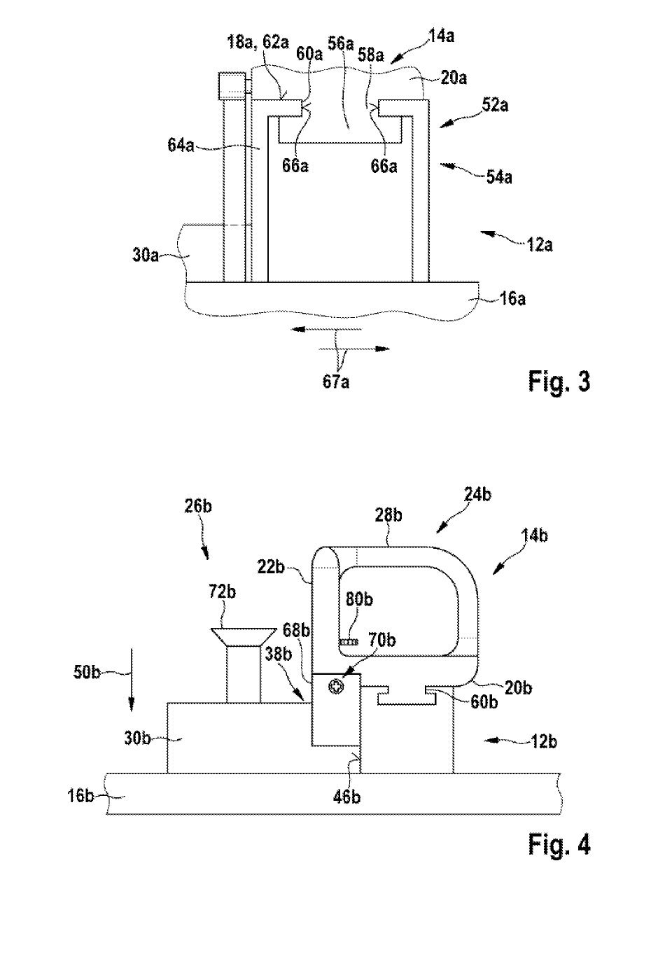

FIG. 3 shows a frontal view of the work piece guide system. The main body 20a of the work piece guide device 14a has a coupling region 52a, in which a vertical guide element 56a and a horizontal guide element 58a are arranged.

The parallel stop unit 12a has a coupling region 54a, in which the support surface 18a and a recess 60a formed in the support surface 18a are arranged.

The vertical guide element 56a and the horizontal guide element 58a are arranged, in an operating state, on a side of the main body 20a facing the parallel stop unit 12a and are formed in one piece with said main body.

The vertical guide element 56a rests on a first vertical guide surface 62a of the parallel stop unit 12, which runs along the support surface 18a. Within the recess 60a formed in the support surface 18a, the vertical guide element 56a rests against a second vertical guide surface 64a, which extends parallel to the first vertical guide surface 62a. The vertical guide element 56a prevents any movement of the work piece guide device 14a in the direction of support 50a.

The horizontal guide element 58a rests against a first and a second horizontal guide surface 66a of the parallel stop unit 12a, each running perpendicular to the support surface 18a. The horizontal guide surfaces 66a are both arranged within the recess 60a. The horizontal guide element 58a thus prevents movement in one of two horizontal directions 67a, which extend in different directions perpendicular to the direction of guidance 44a and perpendicular to the direction of support 50a.

By introducing the vertical guide element 56a and the horizontal guide element 58a of the work piece guide device 14a into the recess 60a in the parallel stop unit 12a, the coupling region 52a of the work piece guide device 14a is coupled to the coupling region 54a of the parallel stop unit 12a.

A further exemplary embodiment of the invention is shown in FIG. 4. The subsequent descriptions are limited substantially to the differences between the exemplary embodiments, wherein reference can be made to the description of the first exemplary embodiment in FIGS. 1 to 3 with regard to components, features and functions that remain the same. To distinguish between the exemplary embodiments, the letter a in the reference signs of the exemplary embodiment in FIGS. 1 to 3 has been replaced by the letter b in the reference signs of the exemplary embodiment in FIG. 4. Reference can also be made in principle to the drawings and/or the description of the first exemplary embodiment in FIGS. 1 to 3 with regard to components that are denoted identically, in particular with regard to components having identical reference signs.

FIG. 4 shows a work piece guide system having a parallel stop unit 12b, a work piece guide device 14b and a feed unit 38b fixed rigidly to a main body 20b of the work piece guide device 14b. The feed unit 38b has a feed plate 68b, which is fixed to the main body 20b by means of a screw connection 70b.

The work piece guide device 14b has a grip 28b, which is formed in one piece with the main body 20b and is formed above the recess 60b. A protection device 22b is likewise formed in one piece with the main body 20b.

A primary plane of extension of a saw blade 72b of a machine tool is arranged parallel to a guide surface 46b of the parallel stop unit 12b in a machining region 26b.

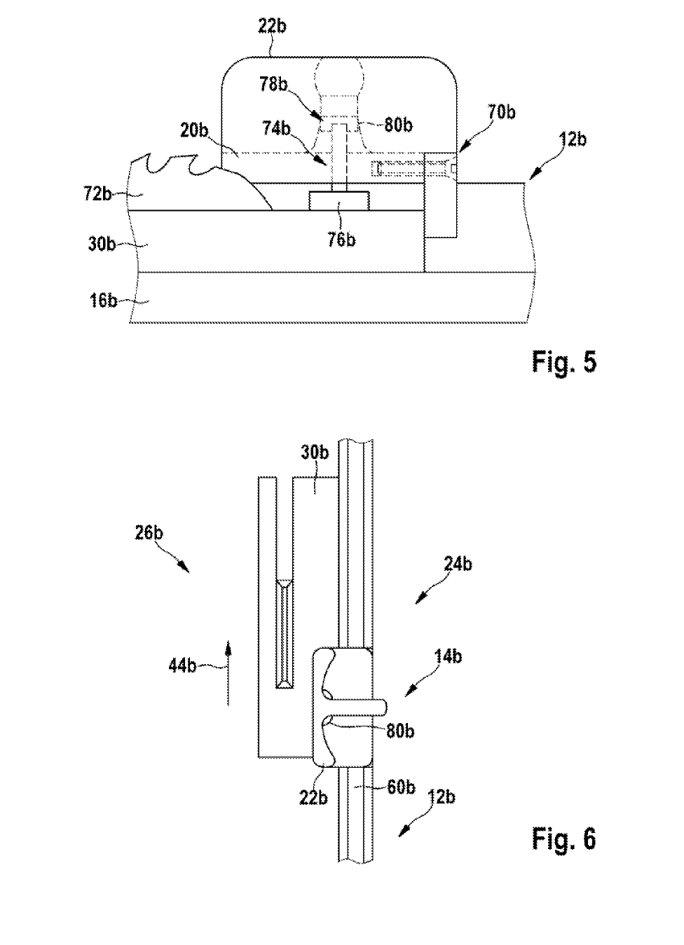

FIG. 5 shows a side view of the work piece guide system. The main body 20b has a hold-down unit 74b, which, in an operating state, presses a work piece 30b onto a work surface 16b via a press plate 76b. Movement of the work piece 30b in a vertical direction, which runs parallel to the direction of support 50b, is thus prevented. The hold-down unit 74b can be adjusted by a latch mechanism 78b. The latch mechanism 78b has a thread and an adjustment wheel 80b in the operating region 24b. A distance between the press plate 76b and the work surface 16b can be adjusted by means of the adjustment wheel 80b.

FIG. 6 shows a plan view of the work piece guide system from FIGS. 4 and 5. The recess 60b in a parallel stop unit 12b extends in a straight line along a direction of guidance 44b. As the work piece guide device 14b is fed along the parallel stop unit 12b, the protection device 22b partially shields the operating region 24b of the work piece guide device 14b in the direction of the machining region 26b.

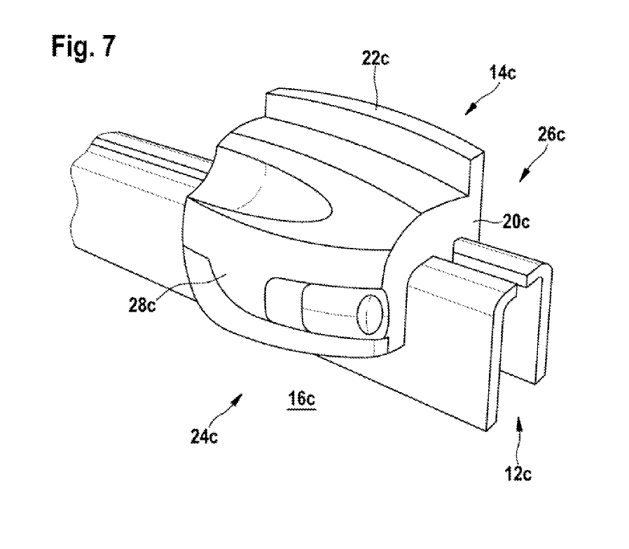

FIG. 7 shows a further exemplary embodiment of a work piece guide system having a parallel stop unit 12c and of a work piece guide device 14c having a main body 20c and protection device 22c. The protection device 22c is formed in one piece with the main body 20c. The protection device 22c is also molded as an increased extension of the main body 20c. A shielding between an operating region 24c and a machining region 26c is arranged above a grip 28c.

The grip 28c is formed as an ergonomically shaped surface of the main body 20c facing away from the machining region. An anti-slip coating is applied to the surface and has a higher coefficient of friction than the main body 20c.

1. A work piece guide system comprising:
a parallel stop unit having at least one first coupling region; and
a work piece guide device having at least one second coupling region,
wherein the at least one first coupling region and the at least one second coupling region are configured to be coupled to each other to guide the work piece guide device along the parallel stop unit.

2. The work piece guide system as claimed in claim 1, wherein:
the at least one first coupling region has at least one vertical guide surface, and
the at least one second coupling region has at least one vertical guide element configured to be guided over at least one vertical guide surface of the at least one second coupling region.

3. The work piece guide system as claimed in claim 1, wherein the at least one second coupling region has at least one horizontal guide element configured to delimit movement of the work piece guide device in two opposed horizontal directions transverse to a direction of guidance.

4. The work piece guide system as claimed in claim 1, further comprising:
a protection device configured to at least partially shield an operating region of the work piece guide device in a direction of a machining region.

5. The work piece guide system as claimed in claim 1, wherein the work piece guide device has an actuation unit configured to change an operating state of a machine tool.

6. The work piece guide system as claimed in claim 1, wherein the work piece guide device has a pivotably mounted feed unit configured to push a work piece along the parallel stop unit.

7. The work piece guide system as claimed in claim 6, further comprising an energy storing unit configured to load a driving stop of the feed unit in a direction of support.

8. The work piece guide system as claimed in claim 6, further comprising a hold-down unit configured to prevent movement of the work piece in a vertical direction.

9. A work piece guide device of a work piece guide system, the work piece guide device comprising:
at least one first coupling region configured to be coupled to at least one second coupling region of a parallel stop unit to guide the work piece guide device along the parallel stop unit.

10. A circular table saw comprising:
a work piece guide system including:
a parallel stop unit having at least one first coupling region; and
a work piece guide device having at least one second coupling region,
wherein the at least one first coupling region and the at least one second coupling region are configured to be coupled to each other to guide the work piece guide device along the parallel stop unit.
